(19) United States
(12) Patent Application Publication
(10) Pub. No.: US 2005/0048317 A1
(43) Pub. Date: Mar. 3, 2005

(54) Electroluminescent device and light-emitting device including the same

(75) Inventors: Satoshi Seo, Kawasaki (JP); Hiroko Abe, Tokyo (JP); Nobuharu Ohsawa, Atsugi (JP); Hisao Ikeda, Atsugi (JP)

Correspondence Address: NIXON PEABODY, LLP, 401 9TH STREET, NW, SUITE 900, WASHINGTON, DC, 20004-2128, US

(73) Assignee: Semiconductor Energy Laboratory Co., Ltd., Atsugi-shi (JP)

(21) Appl. No.: 10/926,955

(22) Filed: Aug. 27, 2004

(30) Foreign Application Priority Data
Aug. 29, 2003 (JP) 2003-308077

(51) Int. Cl. H05B 33/12

(52) U.S. Cl. 428/690; 428/917; 428/212; 313/504; 313/506

(57) ABSTRACT

Driving voltage is reduced for a doped device having a light-emitting layer formed by a host material added with a small amount of a guest material. Specifically, driving voltage is reduced for a doped device formed by a host material added with a red emission material having an electron-withdrawing group as a guest material. Further, color purity of the doped device is improved with reducing driving voltage. Specifically, color purity of the doped device formed by a host material added with a red emission material having an electron-withdrawing group as a guest material is improved with reducing driving voltage. Organic compounds having a hole transportation property are used as a host material 521 for an electroluminescent device having a light-emitting layer 513 formed by the host material 521 and a guest material 522 having an electron-withdrawing group.

### BACKGROUND OF THE INVENTION

1. Field of the Invention

The present invention relates to an electroluminescent device comprising an anode, a cathode, and a layer containing an organic compound (hereinafter, electroluminescent layer) that emits light upon being applied with an electric field, and more particularly such an electroluminescent device that exhibits red emission.

2. Related Art

An electroluminescent device containing organic compounds as a light emitter emits light by applying an electric field to pass an electric current therethrough. It is the emission mechanism that a voltage is applied to an electroluminescent layer interposed between a pair of electrodes, and electrons injected from a cathode and holes injected from an anode are recombined each other within the electroluminescent layer to produce excited molecules (hereinafter, molecular exciton), then, the molecular exciton radiates energy as light while returning to the ground state. The excited states are known as a singlet excited state and a triplet excited state. It is considered that light emission can be obtained through either the excited states.

In such electroluminescent device, an electroluminescent layer is generally formed to have a thin film thickness of from approximately 100 to 200 μm. An electroluminescent device does not require backlight, which is used for the conventional liquid crystal display device, since an electroluminescent layer emits light itself, that is, the electroluminescent device is a self-luminous device. Therefore, it is highly advantageous that an electroluminescent device can be manufactured into an extreme thin film and to be lightweight.

In an electroluminescent layer having a thickness of approximately 100 nm, the time of from the injection to the recombination of carriers takes approximately several ten nanoseconds in the light of the carrier mobility. Hence, the time required for the process of from the injection of carriers to the light emission of the electroluminescent layer is on the order of microsecond even if the process of the recombination of carriers is included therein. Thus, an extreme high response speed is also one of the advantages of an electroluminescent device.

An electroluminescent device containing organic compounds as a light emitter is a carrier injecting type device. Consequently, an electroluminescent device is not required to be applied with a high alternating voltage as in the case with an inorganic EL device. An electroluminescent device can be driven at a low direct-current voltage of from approximately several to ten several volts.

As noted above, an electroluminescent device containing organic compounds as a light emitter has characteristics of thin and lightweight, high response speed, low direct-current-voltage drive, and the like, and is attracted attention as a next generation's flat panel display device. Especially, a light-emitting device including such electroluminescent devices in a matrix has superiority over the conventional liquid crystal display device in a wide viewing angle and high visibility.

In case that such electroluminescent device is utilized for a flat panel display or the like, emission color of light obtained from the electroluminescent device is required to be controlled. As a method for controlling emission color of the electroluminescent device, a method that a light-emitting layer is formed by a host material added with a small amount of guest material (also referred to as a dopant material) to obtain desired emission color derived from the guest material (hereinafter, doping method) is frequently used in recent years. (For example, see U.S. Pat. No. 2,814,435.)

The doping method as typified by the foregoing U.S. Pat. No. 2,814,435 can prevent concentration quenching of light-emitting molecules to obtain high luminance and high efficiency. Accordingly, the doping method is an effective method for emitting red emission material that is susceptible to be concentration quenching. For example, C. H. Chen et al. is disclosed that they synthesized red emission materials such as various 4-dicyanomethylene-4H-pyrane derivatives to use as a guest material in Macromolecular Symposia, No. 125, 49-58 (1997).

However, most electroluminescent devices applied with such a doping method (hereinafter, doped device) have a disadvantage that driving voltage is increased. Especially, it is known that a doped device including a red emission material as a guest material has a strong tendency to increase driving voltage. (For example, see Yoshiharu SATO, “The Japan Society of Applied Physics/Organic Molecular Electronics and Bioelectronics”, vol. 11, No. 1 (2000), 86-99).

Within a doped device, not only a guest material, but also a host material emits light, and so light emission from the device cannot be well controlled. As a result, color purity of light emission may be deteriorated. The phenomenon is occurred when there is a large difference between excited energy of the host material and that of the guest material, and is common in a doped device added with a red emission material as a guest material. It is considered that the phenomenon is prevented by adding an emitting assist dopant having excited energy lying between those of the host material and the guest material. (For example, see Yuji HAMADA et al., Applied Physics Letters, Vol. 75, No. 12, 1682-1684 (1999).)

However, an emitting assist dopant is required to be added in addition to a host material and a guest material in the foregoing method disclosed by Yuji HAMADA et al. Therefore, when a device is manufactured by vacuum vapor deposition, three-source co-evaporation using three evaporation sources is required, and so a process for manufacturing a device becomes complicated. Therefore, a problem has arisen in reproducibility of a device.

As mentioned above, there are problems that the increase of driving voltage and the deterioration of color purity are caused by the fact that emission color cannot be controlled. It has been expected to solve the foregoing problems.

### SUMMARY OF THE INVENTION

In view of the foregoing, it is an object of the present invention to reduce driving voltage of a doped device. It is more specific object of the invention to reduce driving voltage of a doped device including a red emission material as a guest material.

A further object of the invention is to improve color purity of a doped device with reducing driving voltage. An even further object of the invention is to improve color purity of a doped device including a red emission material as a guest material with reducing driving voltage.

The inventors focused on the fact that there is a significant increase in driving voltage of an electroluminescent device including 4-dicyanomethylene-4H-pyran derivatives that are used in the foregoing U.S. Pat. No. 2,814,435 as a guest material. They thought that the increase in driving voltage is caused by an electron-withdrawing group in the 4-dicyanomethylene-4H-pyran derivatives.

Based on the consideration, the inventors found out after their keen examination that driving voltage can be reduced by forming an electroluminescent device added with a guest material having an electron-withdrawing group to have the following structure.

According to one aspect of the invention, an electroluminescent device comprises a light-emitting layer containing a host material and a guest material having an electron-withdrawing group, and an electron transporting layer formed on the light-emitting layer, wherein the host material is an organic compound having a hole transportation property. Further, as the host material, any material can be used as long as it has a hole transportation property. Especially, an organic compound having an aromatic amine skeleton is preferably used as the host material.

Further, the foregoing embodiment is effective for a guest material having various electron-withdrawing groups, and especially effective for a guest material introduced with a cyano group, a halogeno group, a carbonyl group. For example, the foregoing embodiment is effective for a guest material having a 4-dicyanomethylene-4H-pyran skeleton.

Most guest materials having electron-withdrawing groups emit light in the region of from yellow to red by an effect of the substituent. Therefore, another aspect of the invention is that a peak wavelength of an emission spectrum of the foregoing guest material is, in particular, in the range of 560 to 700 run.

The foregoing embodiment of the invention is extremely effective for reducing driving voltage. Additionally, it is possible to improve color purity by preventing an electron transporting layer formed on a light-emitting layer from emitting light.

Therefore, according to further another embodiment of the invention, ionization potential of a host material is larger by 0.3 eV than that of an electron transportation material used for an electron transporting layer. Here, ionization potential of a host material is preferably at most 5.1 eV. Alternatively, ionization potential of an electron transportation material is preferably at least 5.6 eV.

According to still further another embodiment of the invention, holes can be trapped between a light-emitting layer and an electron transporting layer, and a hole trap region formed by a hole trap material having smaller energy gap than that of the electron transportation material used for the electron transporting layer is provided. The hole trap material has preferably smaller ionization potential than those of the host material and the electron transportation material in order to trap holes further effectively. The hole trap region is preferably formed into a layer with a thickness of at most 5 nm or an island like shape since a thick hole trap region may cause difficulty in flowing current.

As the hole trap material, an aromatic hydrocarbon compound having a carbon number of at least 18 as typified by tetracene, perylene, rubrene, and the like, or a carbon allotrope as typified by fullerene (C₆₀) is preferably used.

In case that a light-emitting layer is formed by a host material added with a guest material having an electron-withdrawing group, the inventors found out that a peak wavelength of an emission spectrum of a device is varied depending on a dipole moment of molecules of the host material. Specifically, the peak wavelength of an emission spectrum is blue-shifted with getting smaller dipole moment of molecules of the host material. Therefore, in case that a red light-emitting device is formed by a guest material that has an electron-withdrawing group and that can exhibit red emission, a host material having a small dipole moment may generate orange or yellow emission, and so such the host material may unsuitable for the red light-emitting device.

According to further another aspect of the invention, a peak wavelength of an emission spectrum of a guest material is in a red region in the range of from 600 to 700 nm, and a dipole moment of molecules of a host material is at least 4 debye.

As noted above, the foregoing electroluminescent device has characteristics of low driving voltage and good color purity depending on the structure. Hence, a light-emitting device having characteristics of low power consumption and good color purity can be manufactured by utilizing the foregoing electroluminescent device. Accordingly, a light-emitting device including an electroluminescent device according to the invention is also within the scope of the present invention.

As used herein, the term “light-emitting device” refers to an image display device or a light-emitting device including an electroluminescent device as a light-emitting element. Further, the light-emitting device also refers to a module in which an electroluminescent device attached with a connector such as an anisotropic conductive film, or TAB (Tape Automated Bonding) tape or a TCP (Tape Carrier Package); a module in which the top of a TAB tape or a TCP is provided with a printed wiring board; or a module in which an electroluminescent device is directly installed with an IC (Integrated Circuit) by COG (Chip On Glass).

By practicing the invention, driving voltage can be reduced in a doped device. Especially, driving voltage can be reduced in a doped device including red emission material as a guest material.

Further, by practicing the invention, color purity can be improved in a doped device with reducing driving voltage. Especially, color purity of a doped device added with a red emission material as a guest material can be improved with reducing driving voltage.

These and other objects, features and advantages of the present invention will become more apparent upon reading of the following detailed description along with the accompanied drawings.

### BRIEF DESCRIPTION OF THE DRAWINGS

FIGS. 1A to 1C are band diagrams of the conventional electroluminescent device;

FIG. 2 is a band diagram of an electroluminescent device according to certain aspects of the present invention;

FIG. 3 is a band diagram of an electroluminescent device according to certain aspects of the present invention;

FIG. 4 is a band diagram of an electroluminescent device according to certain aspects of the present invention;

FIG. 5 is a device configuration of an electroluminescent device according to certain aspects of the present invention;

FIG. 6 is a device configuration of an electroluminescent device according to certain aspects of the present invention;

FIG. 7 is a device configuration of the conventional electroluminescent device;

FIGS. 8A and 8B are explanatory views for showing a light-emitting device including an electroluminescent device according to certain aspects of the present invention;

FIGS. 9A to 9G are explanatory views for showing electric appliances including light-emitting devices according to certain aspects of the present invention;

FIG. 10 shows current vs. voltage characteristics according to Example 1 and Comparative Example 1;

FIG. 11 shows current vs. voltage characteristics according to Example 2 and Comparative Example 2;

FIG. 12 shows current vs. voltage characteristics according to Example 5 and Comparative Example 3;

FIG. 13 shows current vs. voltage characteristics according to Example 6 and Comparative Example 4; and

FIG. 14 shows current vs. voltage characteristics according to Example 7 and Comparative Example 5.

### DESCRIPTION OF THE INVENTION

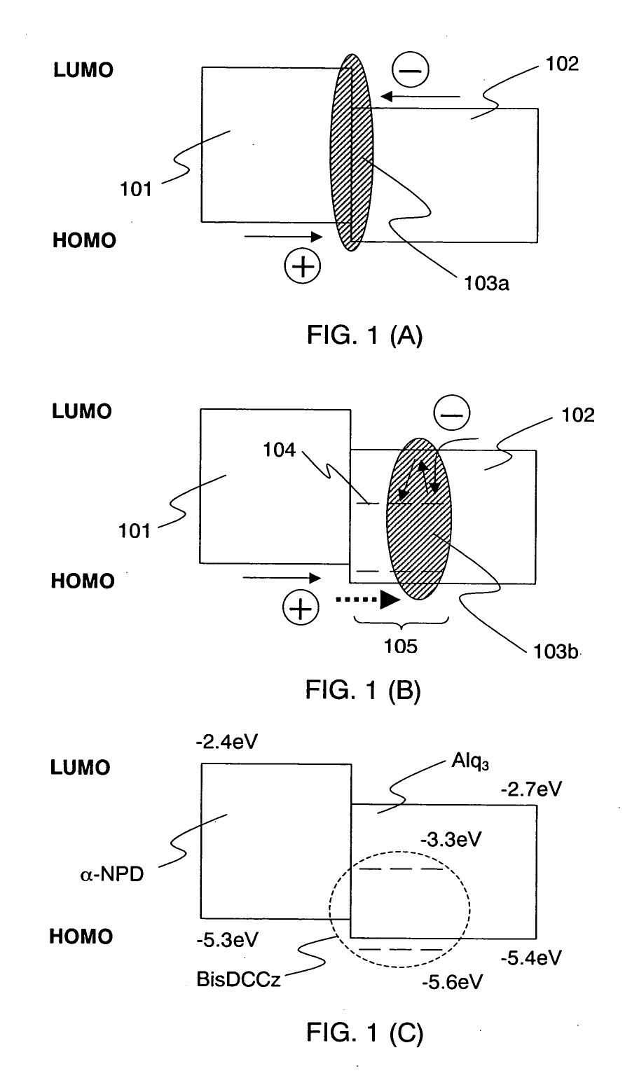

FIG. 1A is a band diagram for the lamination structure often used for an electroluminescent device, that is, a lamination structure formed by stacking a hole transporting layer and an electron transporting layer. As shown in FIG. 1A, since holes and electrons are transported smoothly along with HOMO level of a hole transportation material in a hole transporting layer 101 and along with LUMO level of an electron transportation material in an electron transporting layer 102, respectively, a recombination region of these carriers is located at the vicinity of an interface between the hole transporting layer 101 and the electron transporting layer 102.

Conventionally, based on the structure illustrated in FIG. 1A, a guest material having an electron-withdrawing group is added to the electron transporting layer 102. FIG. 1B is a band diagram for the foregoing structure. The guest material having an electron-withdrawing group has extreme large electron affinity due to the effects of the strong electron-withdrawing property, consequently, LUMO level 104 is located at a low position to form an extreme deep electron trap level.

In this case, in a region 105 doped with a guest material having an electron-withdrawing group, electrons are difficult in transferring due to the deep electron trap level, it may be expected that a carrier recombination region 103b is away from the vicinity of an interface in a lamination structure to be spread toward an electron transporting layer 102. Accordingly, an electron transporting layer formed by an electron transportation material becomes required to transport holes (dotted arrow in the diagram). As a result, the inventors thought that current becomes difficult in flowing and voltage for light emission caused by recombination of carriers (that is, driving voltage) is increased.

In fact, in the case that 4,4′-bis[N-(1-naphtyl)-N-phenyl-amino]-biphenyl (abbreviated α-NPD) is used as a hole transportation material for a hole transporting layer; tris(8-quinolinolato)aluminum (abbreviated Alq₃) is used as an electron transportation material for an electron transporting layer; and 4-dicyanomethylene-2,6-bis[p-(N-carbazolyl)styryl]-4H-pyran (abbreviated BisDCCz) is used as a guest material having a cyano group that is an electron-withdrawing group, the band diagram illustrated in FIG. 1C is formed. Accordingly, the increase of driving voltage derived from an extreme deep electron trap level (−3.3 eV) is to be expected.

The value of the HOMO level illustrated in FIG. 1C (a negative value, its absolute value corresponds to ionization potential) is calculated in accordance with the following procedure, that is, the value of ionization potential of each material in a thin film form is measured by photoelectron spectrometer (AC-2) (RIKEN KEIKI Co., Ltd.), and the measured value is converted into a negative value. The value of the LUMO level is calculated in accordance with the following procedure, that is, absorption spectrum of each material in a thin film state is measured by UV/VIS spectrometer (JASCO International Co., Ltd.), and the value of an energy gap is evaluated by its absorption edge, then, the evaluated value is added to the value of the HOMO level.

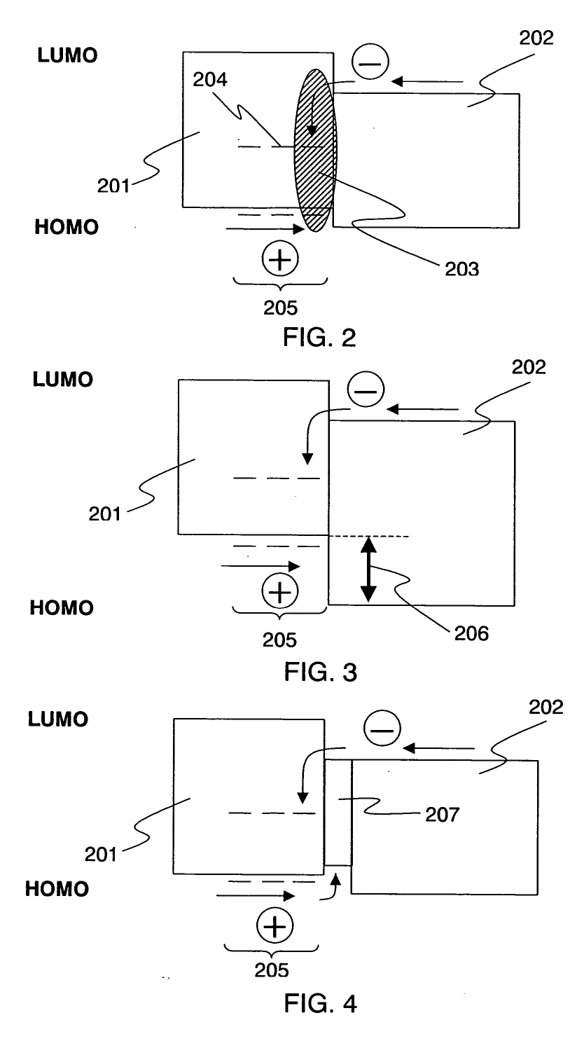

On the other hand, the basic concept of the invention is the structure in which a hole transporting layer is added with a guest material having an electron-withdrawing group to form a light-emitting layer in order to avoid the foregoing phenomenon. FIG. 2 is a band diagram for the foregoing structure. Reference numeral 201 denotes a hole transporting layer; 202, an electron transporting layer; and 205, a region where the hole transporting layer is added with a guest material having an electron-withdrawing group, that is, a light-emitting layer.

In the structure shown in FIG. 2, electrons are passed through the electron transporting layer 202 to be trapped by LUMO level 204 of the guest material at a vicinity of an interface 203 located in the light-emitting layer 205 between the electron transporting layer 202 and the light-emitting layer 205. However, on the contrary to the case shown in FIG. 1, the transportation of holes is easy in the case of this structure since a host material used for the light-emitting layer 205 is a hole transportation material used for the hole transporting layer 201. That is, it can be considered that the recombination of carriers becomes easy since holes are easily transported to the vicinity of interface 203 despite that electrons are trapped in the vicinity of interface 203. As a result, current becomes easily flowed and driving voltage can be reduced compared with the case shown in FIG. 1.

The hole transporting layer 201 and the light-emitting layer 205 illustrated in FIG. 2 are formed by using the same hole transportation material. Alternatively, different hole transportation materials can be used.

As a hole transportation material that can be used as a host material for the light-emitting layer 205, besides the foregoing A-NPD, an organic compound having an aromatic amine skeleton is preferably used such as 4,4′-bis[N-(3-methylphenyl)-N-phenyl-amino]-biphenyl (abbreviated TPD), 4,4′,4″-tris(N,N-diphenyl-amino)-triphenylamine (abbreviated TDATA), 4,4′,4″-tris[N-(3-methylphenyl)-N-phenyl-amino]-triphenylamine (abbreviated MTDATA), 4,4′,4″-tris[N-(1-naphthyl)-N-phenyl-amino]-triphenylamine (abbreviated 1-TNATA), and the like can be used. Further, a metal complex having an aromatic amine skeleton, tris(5-diphenylamino-8-hydroxyquinolinato)aluminum (abbreviated Al(daq)₃), bis (5-diphenylamino-8-hydroxyquinolinato)zinc (abbreviated Zn(daq)₃), a kind of an organometallic complex, tris(1-phenylpirazole)cobalt(III) (abbreviated Co(PPZ)₃), tris(1-(4-methylphenyl)pirazole)cobalt(III) (abbreviated Co(m-PPZ)₃), and the like are also have a hole transportation property.

On the other hand, as a guest material having an electron-withdrawing group used for the light-emitting layer 205, a light-emitting material having an electron-withdrawing group such as cyano group, a halogeno group, a carbonyl group, and the like is used. As a light-emitting material having a cyano group, besides coumarin 337, 4-(dicyanomethylene)-2-[p-(dimethylamino)styryl]-6-methyl-4H-pyran (abbreviated DCM1), 4-(dicyanomethylene)-2-methyl-6-(9-julolidyl)ethinyl-4H-pyran (abbreviated DCM2), 4-(dicyanomethylene)-2,6-bis[p-(dimethylamino)styryl]-4H-pyran (abbreviated BisDCM), a light-emitting material having 4-dicyanomethylene-4H-pyran skeleton such as the foregoing BisDCCz, or the like can be used. As a light-emitting material having a halogeno group, a light-emitting material having a haloalkyl group such as coumarin 152 or coumarin 153 is typically used. As a light-emitting material having a carboxyl group, a light-emitting material having an ester group such as coumarin 314, a light-emitting material having an acyl group such as coumarin 334, and a light-emitting material having a carboxyl group such as coumarin 343 or coumarin-3-carboxylic acid can be used.

As an electron transportation material for forming an electron transporting layer 202, metal complexes such as the foregoing Alq₃, tris(5-methyl-8-quinolinolato)aluminum (abbreviated Almq₃), bis (2-methyl-8-quinolinolato)-4-phenylphenolato-aluminum (abbreviated BAlq), tris(8-quinolinolato)gallium (abbreviated Gaq₃), bis(2-methyl-8-quinolinolato)-4-phenylphenolato-gallium (abbreviated BGaq), bis(10-hydroxybenz)[h]-quinolinato)beryllium (abbreviated BeBq₂), bis [2-(2-hydroxyphenyl)-benzooxazolate] zinc (abbreviated Zn(BOX)₂), and bis [2-(2-hydroxyphenyl)-benzothiazolate] zinc (abbreviated Zn(BTZ)₂). Besides metal complexes, 2-(4-biphenylyl)-5-(4-tert-butylphenyl)-1,3,4-oxadiazole (abbreviated PBD), and 1,3-bis[5-(p-tert-butylphenyl)-1,3,4-oxadiazole-2-yl] benzene (abbreviated OXD-7), 3-(4-tert-butylphenyl)-4-phenyl-5-(4-biphenylyl)-1,2,4-triazole (abbreviated TAZ), and 3-(4-tert-butylphenyl)-4-(4-ethylphenyl)-5-(4-biphenylyl)-1,2,4-triazole (abbreviated p-EtTAZ), bathophenanthroline (abbreviated BPhen), bathocuproin (abbreviated BCP), and the like can be used.

In the case with the structure shown in FIG. 2, there is the possibility that the electron transporting layer 202 emits light depending on the combination of materials. The reason is that a part of holes are entered into the electron transporting layer 202 to excite materials of the electron transporting layer 202 since a recombination region is located at the vicinity of the interface 203. When the phenomenon is occurred, not only a guest material that is originally hoped to be emitted, but also a material used for the electron transporting layer 202 is emitted. Consequently, color purity is deteriorated.

FIG. 3 shows one embodiment that is regarded as a preferable embodiment for the invention. That is, the difference between ionization potential (barrier 206) of a host material (hole transportation material) used for the light-emitting layer 205 and that of an electron transportation material used for the electron transporting layer 202 is increased. Specifically, the barrier 206 may be at least 0.3 eV. According to the structure, the phenomenon that the electron transportation material of the electron transporting layer 202 is excited to emit light can be avoided since holes can be prevented from entering into the electron transporting layer 202.

In order to increase the barrier 206, ionization potential of a host material (hole transportation material) used for the light-emitting layer 205 may be reduced or ionization potential of an electron transportation material used for the electron transporting layer 202 may be increased.

Generally, most electron transportation materials have ionization potential of approximately 5.4 eV or more. (For example, Alq₃ that is a typical electron transportation material has ionization potential of 5.4 eV.) Therefore, it is sufficient that ionization potential of the host material (hole transportation material) is at most 5.1 eV. As specific examples of the host material, TDATA, MTDATA, 1-TNATA, Al(daq)₃, Zn(daq)₃, and the like can be used. For example, ionization potential of 1-TNATA is 5.0 eV.

On the contrary, most hole transportation materials have ionization potential of approximately 5.3 eV or less. (For example, α-NPD that is a typical hole transportation material has ionization potential of 5.3 eV.) Therefore, it is sufficient that ionization potential of the electron transportation material is at least 5.6 eV. As specific examples of the electron transportation material, BAlq, BGaq, PBD, OXD-7, TAZ, p-EtTAZ, BPhen, BCP, and the like can be used. For example, ionization potential of BAlq is 5.6 eV.

As another preferable embodiment of the invention, the structure illustrated in FIG. 4 may be adopted. According to the structure, holes can be trapped between the light-emitting layer 205 and the electron transporting layer 202, and a hole trap region 207 formed by a hole trap material having smaller energy gap than that of an electron transportation material used for the electron transporting layer 202 is provided. Further, according to the structure, the phenomenon that holes enter into the electron transporting layer 202 can be prevented. Additionally, despite that hole trap material is excited, the phenomenon that the excited energy moves into the electron transportation material used for the electron transporting layer 202 can be prevented. Thus, the phenomenon that an electron transportation material used for the electron transporting layer 202 is exited to emit light can be avoided.

If a material having smaller ionization potential than those of a host material used for the light-emitting layer 205 and an electron transportation material used for the electron transporting layer 202 is used as the hole trap material, holes can be effectively trapped as denoted by arrows in FIG. 4. However, a material that can prevent holes from entering into the electron transporting layer 202, and that can prevent the electron transportation material used for the electron transporting layer 202 from emitting light can be utilized as a hole trap material, despite that another structure is adopted. As a specific example of the hole trap material, an aromatic hydrocarbon compound having a carbon number of at least 18 as typified by tetracene, pentacene, perylene, coronene, rubrene, and the like are preferably used for their small ionization potential. Alternatively, carbon allotropes such as fullerene (C₆₀), carbon nanotubes, diamond like carbon (abbreviated DLC), and the like are preferably used for their small energy gap.

In case that the hole trap region is too thick, an electroluminescent device is susceptible to be suffered from harmful effects that electrons are prevented from flowing depending on hole trap materials, or a hole trap material itself is excited. Especially, in order to avoid the harmful effect that the hole trap material emits light, the hole trap region is formed into a layer with a thickness of at most 5 nm in consideration with the distance that enables Foerster energy to transfer from the hole trap material to the guest material.

From the viewpoint of the thickness of at most 5 nm, the hole trap region may be formed into an island-like shape instead of a layer. The hole trap region may be formed into an island-like shape in accordance with a known method. For example, as disclosed in Unexamined Patent Application No. 2001-267077, a method that a material is vacuum deposited so as to have an thinner average thickness on a film thickness monitor than that of a monomolecular film.

As mentioned above, when a light-emitting layer is formed by a host material having a small dipole moment added with a red emission guest material having an electron-withdrawing group for manufacturing a red light-emitting device, emission is blue-shifted compared with the case that the red light-emitting device is formed by a host material having a large dipole moment. In certain instances, red emission with good color purity cannot be exhibited. This phenomenon can be considered as a type of solvent effect.

Alq₃ used conventionally as a host material has two kinds of constitutional isomers. Generally, the constitutional isomer is referred to as a fac-isomer. The dipole moment of the fac-isomer was 9.398 debye calculated by commercially available molecular orbital calculation software, WinMOPAC3.5 (FUJITSU LIMITED). (In addition, the dipole moment of a mer-isomer that is another constitutional isomer was 5.788 debye.) An experiment proved that the device formed by Alq₃ used as a host material added with a red emission guest material having an electron-withdrawing group exhibits a better red emission as emission color than that of a device formed by a host material having a further small dipole moment (specifically, less than 4 debye) by way of experiment.

As discussed above, the size of a dipole moment is an important factor for exhibiting red emission with good color purity. However, Alq₃ is unsuitable for a host material in the present invention since Alq₃ is an electron transportation material.

Therefore, in the case that a red light-emitting device is manufactured according to the invention, a material having a large dipole moment and a hole transportation property such as Alq₃ is preferably used. Most organic compounds having general aromatic amine skeletons have small dipole moments. On the contrary, metal complexes having a hole transportation property such as Al(daq)₃, Zn(daq)₃, Co(PPZ)₃, or Co(m-PPZ)₃ are preferably used for their large dipole moments. For example, calculation indicated that the dipole moment of a fac-isomer Al(daq)₃ was 9.221 debye. (In addition, a mer-isomer that is another constitutional isomer was 4.639 debye.)

According to one aspect of the invention, a dipole moment of molecules of a host material is preferably at least 4 debye when a peak wavelength of an emission spectrum of a guest material of an electroluminescent device having the foregoing structure is in a range of 600 to 700 nm.

Then, embodiment of an electroluminescent device according to the invention is explained in detail hereinafter. An electroluminescent layer of the electroluminescent device according to the invention may comprise at least the foregoing light-emitting layer and electron transporting layer. Hence, the electroluminescent layer may be formed by combining layers having properties except light-emission (a hole injecting layer, a hole transporting layer, an electron transporting layer, and an electron injecting layer) that is known in the conventional electroluminescent device.

Embodiment 1

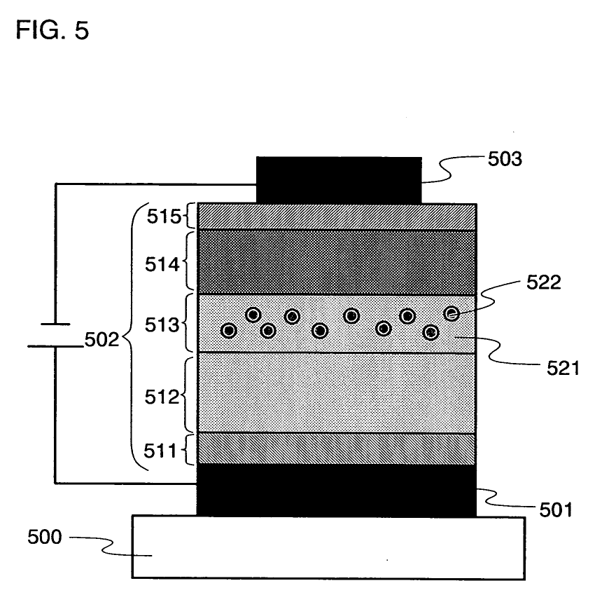

In Embodiment 1, a device configuration of an electroluminescent device comprising a hole injecting layer, a hole transporting layer, a light-emitting layer, an electron transporting layer, and an electron injecting layer is explained with reference to FIG. 5. FIG. 5 shows an electroluminescent device manufactured in accordance with the following procedure, that is, a first electrode 501 is formed over a substrate 500, an electroluminescent layer 502 is formed over the first electrode 501, and a second electrode 503 is formed over the electroluminescent layer 502.

As a material for the substrate 500, the material used for the conventional electroluminescent device, for example, glass, quartz, transparent plastic, or the like, can be used.

Further, according to Embodiment 1, the first electrode 501 serves as an anode, and the second electrode 503 serves as a cathode.

As an anode material for the first electrode 501, metals having a large work function (at least 4.0 eV), alloys, electric conductive compounds, or a mixture of the above materials are preferably used. As a specific example of an anode material, in addition to ITO (indium tin oxide), IZO (indium zinc oxide) that is a mixture of indium oxide and zinc oxide (ZnO) of from 2 to 20%; aurum (Au); platinum (Pt); nickel (Ni); tungsten (W); chromium (Cr); molybdenum (Mo); iron (Fe); cobalt (Co); copper (Cu); palladium (Pd); metal nitrides (TiN or the like) can be used.

On the other hand, as a cathode material for the second electrode 503, metals having a small work function (at most 3.8 eV), alloys, electric conductive compounds, or a mixture of the above are preferably used. As a specific example of cathode materials, metals belonging to a 1 or 2 group of the periodic table of the elements, that is, alkali metals such as Li or Cs; alkali earth metals such as Mg, Ca, Sr; alloys including the above elements (Mg:Ag, Al:Li); rare earth metals such as Er, Yb, or the like; and alloys including the rare earth metals. In addition, the second electrode 503 can also be formed by metals or inorganic conductive compounds such as Al, Ag, or ITO by utilizing an electron injecting layer as will hereinafter be described.

The first electrode 501 and the second electrode 503 can be formed by vapor deposition, sputtering, or the like. These electrodes are preferably formed to have thicknesses of from 10 to 500 nm.

The electroluminescent device according to the invention has the structure that light resulted from the recombination of carriers in the electroluminescent layer 502 is emitted to outside through either the first electrode 501 or the second electrode 503, or both of the electrodes. Therefore, the first electrode 501 is formed by a transparent material in case of emitting light from the first electrode 501, and the second electrode 503 is formed by a light-transmitting material in case of emitting light from the second electrode 503.

The electroluminescent layer 502 is formed by stacking a plurality of layers. In Embodiment 1, the electroluminescent layer 502 is formed by stacking a hole injecting layer 511, a hole transporting layer 512, a light-emitting layer 513, an electron transporting layer 514, an electron injecting layer 515. These layers can be formed by vacuum vapor deposition or wet coating.

As a hole injection material for the hole injecting layer 511, porphyrin compounds are useful among organic compounds such as phthalocyanine (abbreviated H₂-Pc), copper phthalocyanine (abbreviated Cu-Pc), or the like. Further, chemical-doped conductive polymer compounds can be used, such as polyethylene dioxythiophene (abbreviated PEDOT) doped with polystyrene sulfonate (abbreviated PSS), or polyaniline (PAni). Alternatively, an inorganic semiconductor layer such as Vo_{X}, or MoO_{X}, or a ultra thin film of inorganic insulator such as Al₂O₃.

As a hole transporting material for the hole transporting layer 512, the foregoing α-NPD, TPD, TDATA, MTDATA, 1-TNATA, Al(daq)₃, Zn(daq)₃, Co(PPZ)₃, Co(m-PPZ)₃, or the like can be used.

The light-emitting layer 513 is formed by a host material 521 having a hole transportation property and a guest material 522 having an electron-withdrawing group. As the host material 521 having a hole transportation property, the foregoing hole transportation material, which may be the same as or different from that used for the hole transporting layer 512, can be used. As the guest material having an electron-withdrawing group, the foregoing DCM1, DCM2, BisDCM, BisDCCz, coumarin 337, coumarin 152, coumarin 153, coumarin 314, coumarin 334, coumarin 343, coumarin-3-carboxylic acid, or the like can be used.

As an electron transporting material for the electron transporting layer 514, the foregoing Alq₃, Almq₃, BAlq, Gaq₃, BGaq, BeBq₂, Zn(BOX)₂, Zn(BTZ)₂, PBD, OXD-7, TAZ, p-EtTAZ, BPhen, BCP, or the like can be used.

As an electron injecting material for the electron injecting layer 515, the foregoing electron transportation material can be used. Alternatively, alkali metal halides such as LiF or CsF, alkali earth metal halides such as CaF₂, or an ultra thin film of insulator, for example, alkali metal oxides such as LiO₂ is frequently used. Alternatively, alkali metal complexes such as lithium acetylacetonate (abbreviated Li(acac)) or 8-quinolinolato-lithium (abbreviated Liq) can be effectively used. Further, a layer formed by mixing the foregoing electron transportation material and metals having a small work function such as Mg, Li, or Cs can be used as the electron injecting layer 515.

Accordingly, an electroluminescent device according to the invention comprising the light-emitting layer 513 containing the host material 521 with a hole transportation property and the guest material 522 with an electron-withdrawing group, and the electron transporting layer 514, which is formed on the light-emitting layer 513, can be manufactured.

Embodiment 2

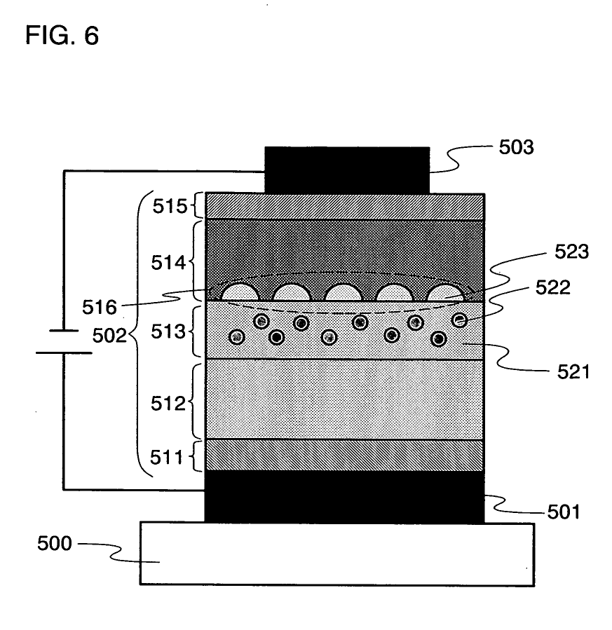

In Embodiment 2, the device configuration disclosed in Embodiment 1 added with a hole trap region is explained with reference to FIG. 6. Through FIG. 6, like components are denoted by like numerals as of FIG. 5.

As shown in FIG. 6, a hole trap region 516 is provided between a light-emitting layer 513 and an electron transporting layer 514. The hole trap region 516 is formed into an island-like shape in FIG. 6. Alternatively, the hole trap region 516 may be formed into a layer with a thickness of at most 5 nm.

As a material 523 for the hole trap region 516, as mentioned above, tetracene, pentacene, perylene, coronene, rubrene, fullerene (C₆₀), carbon nanotubes, DLC, and the like can be used.

Accordingly, an electroluminescent device according to the invention comprising the light-emitting layer 513 containing the host material 521 with a hole transportation property and the guest material 522 with an electron-withdrawing group, the electron transporting layer 514, which is formed on the light-emitting layer 513, and the hole trap region 516 provided between the light-emitting layer 513 and the electron transporting layer 514 can be manufactured.

### EXAMPLE 1

In Example 1, an example of a method for manufacturing an electroluminescent device according to the present invention illustrated in FIG. 5 is explained specifically.

An anode 501 was formed over a glass substrate 500 having an insulated surface. As a material for the anode 501, ITO that is a transparent conductive film was used. The anode 501 was deposited by sputtering to have a thickness of 110 nm. The size of the anode 501 was 2×2 mm.

After washing and drying the substrate provided with the anode 501, an electroluminescent layer 502 was formed over the anode 501. Firstly, the substrate provided with the anode 501 was secured so as to be face down by a substrate holder installed in a vacuum deposition device. That is, the surface provided with the anode 501 was placed face down. Then, Cu-Pc was deposited to have a thickness of 20 nm by vacuum vapor deposition with resistance heating. The deposited film serves as a hole injecting layer 511. Secondly, α-NPD that is a hole transportation material was deposited to have a thickness of 25 nm in accordance with the same procedure as that for the hole injecting layer. The deposited film serves as a hole transporting layer 512.

As a host material 521 for a light-emitting layer 513, α-NPD that is a hole transportation material was used. As a guest material 522 for the light-emitting layer 513, BisDCM having an electron-withdrawing group was used. The light-emitting layer 513 was formed by co-evaporation of the host material and the guest material so that the concentration of the BisDCM is 2 wt %. The light-emitting layer 513 was formed to have a thickness of 15 nm.

Then, Alq₃ that is an electron transportation material was deposited to form an electron transporting layer 514 with a thickness of 75 nm by vacuum vapor deposition. And then, CaF₂ was deposited as an electron injecting layer 515 with a thickness of 1 nm by vacuum vapor deposition. Thus formed hole injecting layer 511, the hole transporting layer 512, the light-emitting layer 513, the electron transporting layer 514, and the electron injecting layer 515 serve as an electroluminescent layer 502. The electroluminescent layer 502 has a total thickness of 136 nm.

Lastly, a cathode 503 was formed. According to Example 1, aluminum (Al) was deposited to have a thickness of 200 nm as the cathode 503 by vacuum vapor deposition with resistance heating.

When voltage of 10 V was applied to thus manufactured electroluminescent device according to the invention, current (current density) flowed at 6.83 mA/cm², and a luminance of 127 cd/m² was obtained. The peak wavelength of an emission spectrum was at 642 nm.

### COMPARATIVE EXAMPLE 1

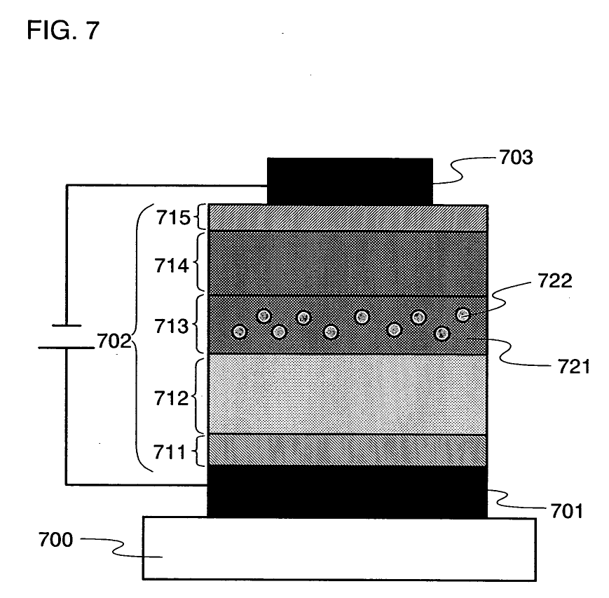

The conventional electroluminescent device including a light-emitting layer formed by an electron transportation material added with a guest material having an electron-withdrawing group was manufactured to compare with the electroluminescent device explained in Example 1. FIG. 7 shows the device configuration according to this comparative example.

As in the case with Example 1, an electroluminescent layer 702 was formed over a glass substrate 700 provided with ITO with a thickness of 110 nm as an anode 701. After washing and drying the substrate, the substrate provided with the anode 701 was secured by a substrate holder mounted on a vacuum deposition device so as to be face down, that is, the surface provided with the anode 701 was placed face down. Then, Cu-Pc was deposited to have a thickness of 20 nm by vacuum vapor deposition with resistance heating. The deposited film was a hole injecting layer 711. And then, α-NPD that is a hole transportation material was deposited in accordance with the same procedure as that used for the hole injecting layer to have a thickness of 40 nm. The deposited film serves as a hole transporting layer 712.

As a host material 721 for a light-emitting layer 713, Alq₃ that is an electron transportation material was used. As a guest material 722 for the light-emitting layer 713, BisDCM having an electron-withdrawing group, which is also used in Example 1, was used. The light-emitting layer 713 was formed by co-evaporation of the host material and the guest material so that the concentration of the BisDCM is 2 wt %. The light-emitting layer 713 was formed to have a thickness of 15 nm.

Alq₃ that is an electron transportation material was deposited to form an electron transporting layer 714 with a thickness of 60 nm by vacuum vapor deposition. Then, CaF₂ was deposited as an electron injecting layer 715 with a thickness of 1 nm by vacuum vapor deposition. Thus formed hole injecting layer 711, the hole transporting layer 712, the light-emitting layer 713, the electron transporting layer 714, and the electron injecting layer 715 serve as an electroluminescent layer 702. The electroluminescent layer 702 has a total thickness of 136 nm that is the same as that explained in Example 1.

Lastly, a cathode 703 was formed. According to Example 1, aluminum (Al) was deposited to have a thickness of 200 nm as the cathode 703 by vacuum vapor deposition with resistance heating.

When voltage of 10 V was applied to thus manufactured electroluminescent a luminance of 27.1 cd/m² was obtained. The peak wavelength of an emission spectrum was at 666 nm.

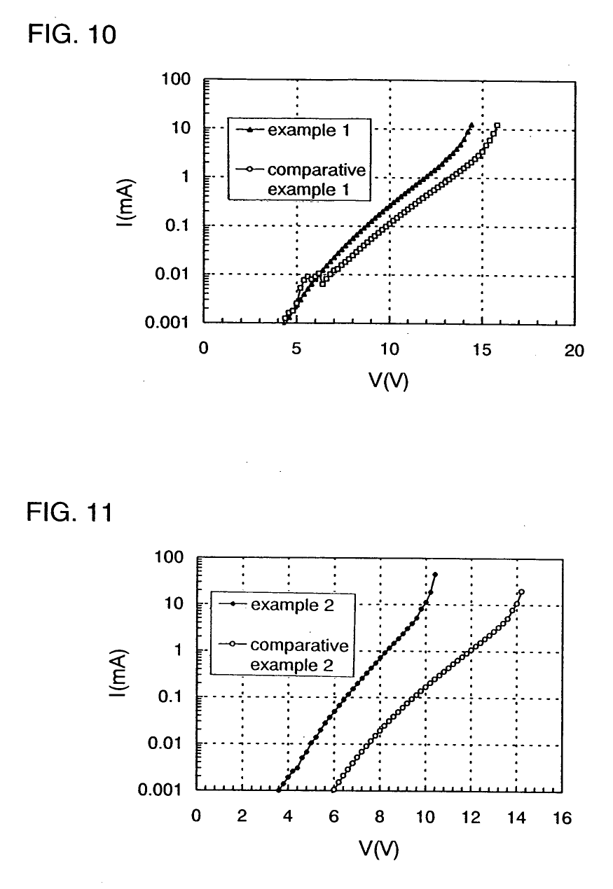

From the foregoing results, the driving voltage of the electroluminescent device according to the invention can be reduced despite the peak wavelength of an emission spectrum is slightly blue-shifted. FIG. 10 shows current vs. voltage characteristics of the electroluminescent devices explained in Example 1 and Comparative Example 1. As is shown in FIG. 10, a current flow became easily in line with expectations.

### EXAMPLE 2

An electroluminescent device formed by using different host material from that used in Example 1 is specifically explained in Example 2.

FIG. 5 shows the device configuration of the electroluminescent device. A substrate 500, an anode 501, and a cathode 503 have the same structure as those explained in Example 1. The electroluminescent layer 502 was formed by stacking a hole injecting layer 511 formed by CuPc with a thickness of 20 nm, a hole transporting layer 512 formed by α-NPD with a thickness of 30 nm, a light-emitting layer 513 formed by 2,3-bis(4-diphenylaminophenyl)quinoxaline (abbreviated TPAQn) dispersed with 1 wt % of BisDCM with a thickness of 30 nm, an electron transporting layer formed by Alq₃ with a 20 nm, and an electron injecting layer formed by CaF₂ with a thickness of 2 nm. The total thickness of the electroluminescent layer 502 is 102 nm. Further, TPAQn has a hole transportation property since it is a bipolar material.

When voltage of 10 V was applied to thus manufactured electroluminescent device according to the invention, current (current density) flowed at 283 mA/cm², and luminance of 1350 cd/m² was obtained. The peak wavelength of an emission spectrum was at 616 nm.

### COMPARATIVE EXAMPLE 2

The conventional electroluminescent device including a light-emitting layer formed by an electron transportation material added with a guest material having an electron-withdrawing group was manufactured to compare with the electroluminescent device explained in Example 2. The device configuration of this comparative example is the same as that illustrated in FIG. 7.

The substrate 700, the anode 701, and the cathode 703 have the same structure as those explained in Example 2. The electroluminescent layer 702 was formed by stacking a hole injecting layer 711 formed by CuPc with a thickness of 20 nm, a hole transporting layer formed by α-NPD with a thickness of 30 nm, a light-emitting layer 713 formed by BAl that is an electron transportation material added with BisDCM of 1 wt % with a thickness of 30 nm, an electron transporting layer formed by Alq₃ with a 20 nm, and an electron injecting layer formed by CaF₂ with a thickness of 2 nm. The total thickness of the electroluminescent layer 702 is 102 nm that is the same as that explained in Example 2.

When voltage of 10 V was applied to thus manufactured electroluminescent device according to the invention, current (current density) at 4.23 mA/cm² flowed, and a luminance of 30.9 cd/m² was obtained. The peak wavelength of an emission spectrum was at 619 nm.

From the foregoing result, the peak wavelength of an emission spectrum of an electroluminescent device according to the invention is similarly to that of the conventional one and the driving voltage of the electroluminescent device can be reduced. FIG. 11 shows current vs. voltage characteristics of the electroluminescent devices explained in Example 2 and Comparative Example 2. As is shown in FIG. 11, a current flow became easily in line with expectations.

### EXAMPLE 3

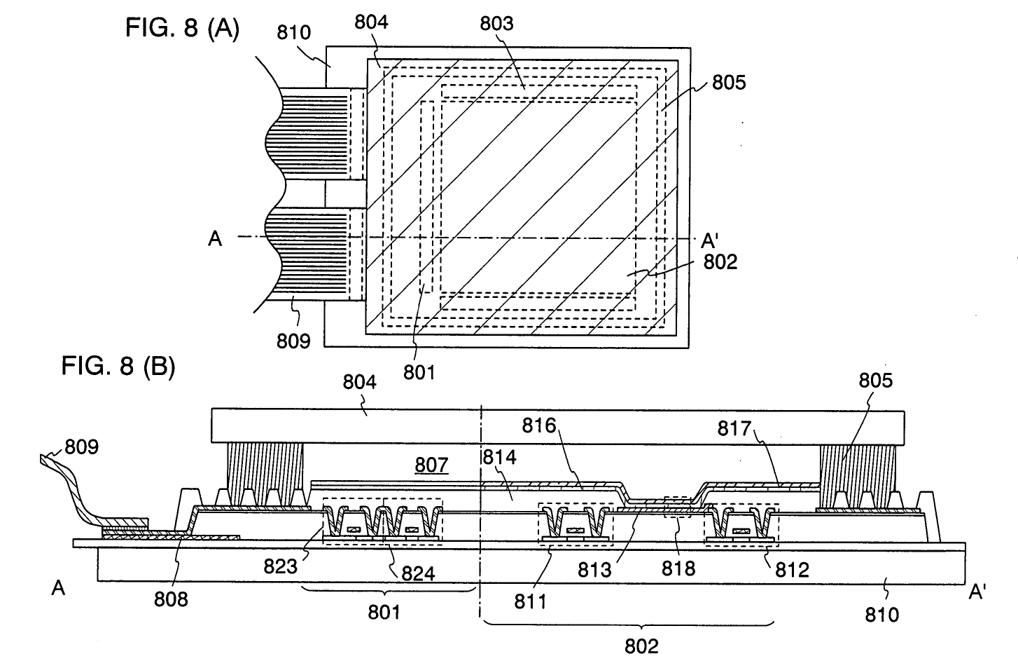

Hereinafter, a light-emitting device that has a pixel portion including electroluminescent devices according to the present invention will be explained with reference to FIGS. 8A and 8B. FIG. 8A is a top view of the light-emitting device. FIG. 8B is a cross-sectional view of FIG. 8A taken along line A-A′. Reference numeral 801 shown by a dotted line denotes a drive circuit portion (a source driver circuit); 802, a pixel portion; and 803, a driver circuit portion (a gate side driver circuit). Further, reference numeral 804 denotes a sealing substrate; 805, sealing agent; and 807, space surrounded by the sealing agent 805.

Further, reference numeral 808 denotes a wiring for transimitting signals to be inputted to the source signal line driver circuit 801 and the gate signal line driver circuit 803. The wiring 808 receives video signals, clock signals, start signals, reset signals, and the like from an FPC (Flexible Print Circuit) 809 serving as an external input terminal. Though only FPC is illustrated here, the FPC can be provided with a print wiring board (PWB). The light-emitting device disclosed in this specification refers to not only a light-emitting device itself but also a light-emitting device provided with an FPC or a PWB.

Then, the cross-sectional structure is explained with reference to FIG. 8B. A driver citcuit portion and a pixel portion are formed over a substrate 810. Here, a source driver circuit 801 as a driver circuit portion and a pixel portion 802 are illustrated.

In the source driver cirucit 801, a CMOS cirucit composed of an n-channel TFT 823 and a p-channel TFT 824 is formed. The TFT for forming a driver circuit may be formed by a known CMOS circuit, PMOS circuit, or NMOS circuit. In this embodiment, a driver integrated type in which a driver circuit is formed over a substrate, but not exclusively, is described. The driver circuit can also be formed outside instead of over a substrate.

The pixel portion 802 is composed of a plurality of pixels including a switching TFT 811, a current control TFT 812, and a first electrode (anode) 813 connected electrically to the drain of the current control TFT 812. Further, an insulator 814 is formed to cover the edge of the first electrode 813. Here, the insulator 814 is formed by a positive type photosensitive acrylic resin film.

In order to improve the coverage, the upper edge portion or the lower edge portion of the insulator 814 is formed to have a curved surface having a radius of curvature. For example, when a positive photosensitive acrylic resin film is used for forming the insulator 814, it is preferable that only the upper edge portion of the insulator 814 is formed to have a curved surface having a radius of curvature (0.2 to 3 μm). As materials for the insulator 814, either a negative type photosensitive resin that becomes insoluble to etchant by light or a positive type photosensitive resin that becomes dissoluble to etchant by light can be used.

An electroluminescent layer 816 and a second electrode 817 are formed over the first electrode 813, respectively. As a material for the first electrode 813 serving as an anode, a material having a large work function is preferably used. For instance, the first electrode can be formed by a single layer such as an ITO (indium tin oxide) film, an IZO (indium zinc oxide) film, a titanium nitride film, a chromic film, a tungsten film, a Zn film, or a Pt film; a lamination layer comprising a titanium nitride and aluminum as its main component; a three lamination layer comprising a titanium nitride film, a film containing aluminum as its main component, and another titanium nitride film; or the like. In case of adopting the lamination layer, the first electrode can be formed to have low resistance as a wiring, make good ohmic contact, and serve as an anode.

The electroluminescent layer 816 is formed by vapor deposition using an evaporation mask, or ink jetting. The electroluminescent layer 816 may be formed to have the same structure as that explained in Examples 1 and 2.

As materials for the second electrode (cathode) 817 formed over the electroluminescent layer 816, materials having a small work function (Al, Ag, Li, Ca, or alloys of these elements such as MgAg, MgIn, AlLi, CaF₂, or CaN) can be used. In case that light generated in the electroluminescent layer 816 passes through the second electrode (cathode) 817, the second electrode (cathode) 817 is preferably formed by a lamination layer comprising a thin metal film and a transparent conductive film (indium tin oxide (ITO), indium zinc oxide (IZO), zinc oxide (ZnO), or the like).

The sealing substrate 804 is pasted onto the substrate 810 with the sealing agent 805 to encapsulate an electroluminescent device 818 within the space 807 surrounded by the substrate 810, the sealing substrate 804, and the sealing agent 805. The space 807 may be filled with inert gases (such as nitrogen or argon). Alternatively, the space 807 may be filled with the sealing agent 805.

The sealing agent 805 is preferably formed by epoxy-based resin. In addition, it is desirable that the material for the sealing agent inhibits the penetration of moisture or oxygen as much as possible. As materials for the sealing substrate 804, a plastic substrate such as FRP (fiberglass-reinforced plastics), PVF (polyvinyl fluoride), Myler, polyester, or acrylic can be used besides a glass substrate or a quartz substrate.

Accordingly, a light-emitting device comprising an electroluminescent device according to the invention can be obtained.

### EXAMPLE 4

Various electric appliances including a light-emitting device with an electroluminescent device according to the present invention as a display portion can be provided.

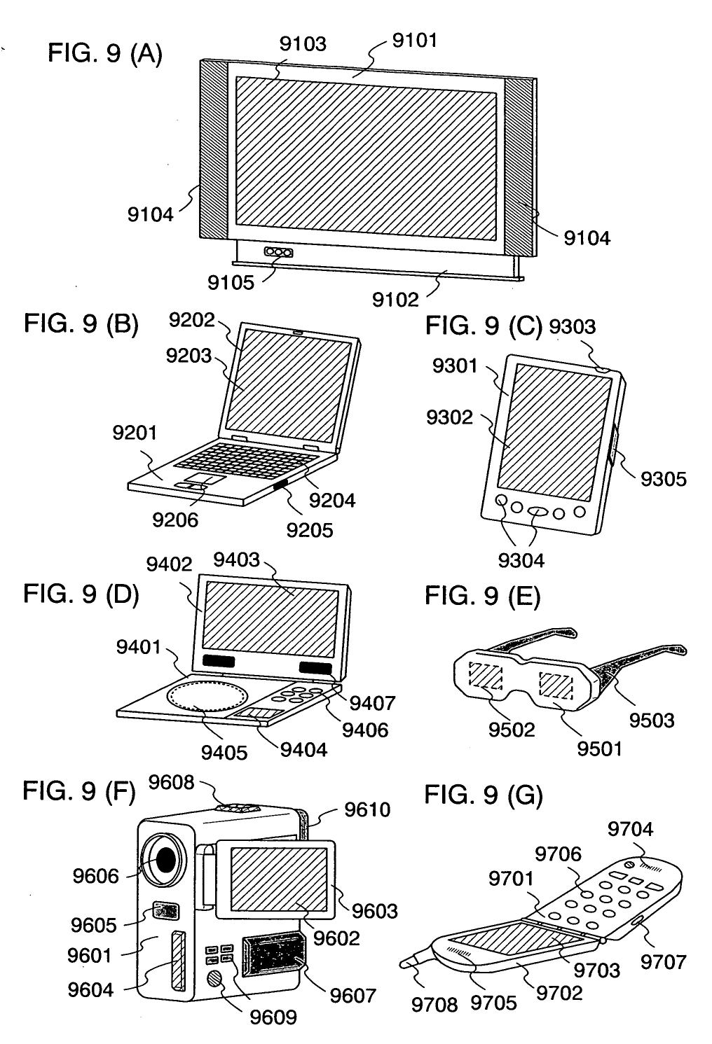

Given as examples of such electric appliances including a light-emitting device with an electroluminescent device according to the invention: a video camera, a digital camera, a goggles-type display (head mount display), a navigation system, a sound reproduction device (a car audio equipment, an audio set and the like), a laptop personal computer, a game machine, a personal digital assistant (a mobile computer, a cellular phone, a portable game machine, an electronic book, or the like), an image reproduction device including a recording medium (more specifically, a device which can reproduce a recording medium such as a digital versatile disc (DVD) and so forth, and includes a display for displaying the reproduced image), or the like. FIGS. 9A to 9G show various specific examples of such electric appliances.

FIG. 9A illustrates a display device which includes a housing 9101, a support base 9102, a display portion 9103, a speaker portion 9104, a video input terminal 9105, or the like. A light-emitting device including an electroluminescent device according to the invention can be used for the display portion 9103. The display device refers to all of the display devices for displaying information, such as a personal computer, a receiver of TV broadcasting, and an advertising display.

FIG. 9B illustrates a laptop computer which includes a main body 9201, a housing 9202, a display portion 9203, a keyboard 9204, an external connection port 9205, a pointing mouse 9206, or the like. A light-emitting device including an electroluminescent device according to the invention can be used to the display portion 9203.

FIG. 9C illustrates a mobile computer which includes a main body 9301, a display portion 9302, a switch 9303, an operation key 9304, an infrared port 9305, or the like. A light-emitting device including an electroluminescent device according to the invention can be used to the display portion 9302.

FIG. 9D illustrates an image reproduction device including a recording medium (more specifically, a DVD reproduction device), which includes a main body 9401, a housing 9402, a display portion A 9403, another display portion B 9404, a recording medium (DVD or the like) reading portion 9405, operation keys 9406, a speaker portion 9407 or the like. The display portion A 9403 is used mainly for displaying image information, while the display portion B 9404 is used mainly for displaying character information. A light-emitting device including an electroluminescent device according to the invention can be used to the display potion A 9403 and the display portion B 9404. Note that the image reproduction device including a recording medium further includes a domestic game machine or the like.

FIG. 9E illustrates a goggle type display (head mounted display), which includes a main body 9501, a display portion 9502, and an arm portion 9503. A light-emitting device including an electroluminescent device according to the invention can be used to the display portion 9502.

FIG. 9F illustrates a video camera which includes a main body 9601, a display portion 9602, a housing 9603, an external connecting port 9604, a remote control receiving portion 9605, an image receiving portion 9606, a battery 9607, a sound input portion 9608, an operation key 9609, an eyepiece potion 9610, or the like. A light-emitting device including an electroluminescent device according to the invention can be used to the display portion 9602.

FIG. 9G illustrates a cellular phone which includes a main body 9701, a housing 9702, a display portion 9703, a sound input portion 9704, a sound output portion 9705, an operation key 9706, an external connecting port 9707, an antenna 9708, or the like. A light-emitting device including an electroluminescent device according to the invention can be used to the display portion 9703. Note that the display portion 9703 can reduce power consumption of the cellular phone by displaying white-colored characters on a black-colored background.

As set forth above, a light-emitting device including an electroluminescent device according to the invention can be applied variously to a wide range of electric appliances. The light-emitting device can be applied to various fields' electric appliances.

### EXAMPLE 5

In Example 5, an example of a method for manufacturing an electroluminescent device by a guest material having an electron-withdrawing group different from those described in Examples 1 and 2 is specifically explained. FIG. 5 shows the device configuration of the electroluminescent device.

An anode 501 was formed over a glass substrate 500 having an insulated surface. As a material for the anode 501, indium tin oxide (ITSO) doped with silicon oxide were used. The anode 501 was deposited by sputtering to have a thickness of 110 nm. The size of the anode 501 was 2×2 mm.

After washing and drying the substrate provided with the anode 501, an electroluminescent layer 502 was formed over the anode 501. Firstly, the substrate provided with the anode 501 was secured so as to be face down by a substrate holder installed in a vacuum deposition device. That is, the surface provided with the anode 501 was placed face down. Then, 4,4′-bis[N-[4-{N,N-bis(3-methylphenyl)amino}phenyl]-N-phenylamino]biphenyl (abbreviated DNTPD) was deposited to have a thickness of 50 nm by vacuum vapor deposition with resistance heating. The deposited film serves as a hole injecting layer 511. Secondly, α-NPD that is a hole transportation material was deposited to have a thickness of 10 nm in accordance with the same procedure as that for the hole injecting layer. The deposited film serves as a hole transporting layer 512.

As a host material 521 for a light-emitting layer 513, c-NPD that is a hole transportation material was used. As a guest material 522 having an electron-withdrawing group for the light-emitting layer 513, coumarin 153 was used. The light-emitting layer 513 was formed by co-evaporation of the host material and the guest material so that the concentration of the coumarin 153 was 0.5 mass %. The light-emitting layer 513 was formed to have a thickness of 30 nm. The coumarin 153 is a compound having a halogeno group that is an electron-withdrawing group, since it has a trifluoromethyl group.

Then, Alq₃ that is an electron transportation material was deposited to form an electron transporting layer 514 with a thickness of 30 nm by vacuum vapor deposition. And then, CaF₂ was deposited as an electron injecting layer 515 with a thickness of 1 nm by vacuum vapor deposition. Thus formed hole injecting layer 511, the hole transporting layer 512, the light-emitting layer 513, the electron transporting layer 514, and the electron injecting layer 515 serve as an electroluminescent layer 502. The electroluminescent layer 502 has a total thickness of 121 nm.

Lastly, a cathode 503 was formed. According to Example 5, aluminum (Al) was deposited to have a thickness of 150 nm as the cathode 503 by vacuum vapor deposition with resistance heating.

When voltage of 6.0 V was applied to thus manufactured electroluminescent device according to the invention, current (current density) flowed at 51.3 mA/cm², and a luminance of 1590 cd/m² is obtained. The peak wavelength of an emission spectrum was at 518 nm.

### COMPARATIVE EXAMPLE 3

The conventional electroluminescent device including a light-emitting layer formed by an electron transportation material added with a guest material having an electron-withdrawing group was manufactured to compare with the electroluminescent device explained in Example 5. The device configuration of the electroluminescent device is the same as that explained in Example 5 except a light-emitting layer 513.

As a host material for a light-emitting layer 513, Alq₃ that is a hole transportation material was used. As a guest material for the light-emitting layer 513, coumarin 153 having an electron-withdrawing group, which is also used in Example 5, was used. The light-emitting layer 513 was formed by co-evaporation of the host material and the guest material so that the concentration of the coumarin 153 is 0.5 mass %. The light-emitting layer 513 was formed to have a thickness of 30 nm. An electroluminescent layer 502 has a total thickness of 121 nm that is the same as that explained in Example 5.

When voltage of 6.0 V was applied to thus manufactured electroluminescent device according to the invention, current (current density) flowed at 18.8 mA/cm², and a luminance of 1250 cd/m² was obtained. The peak wavelength of an emission spectrum was at 530 nm.

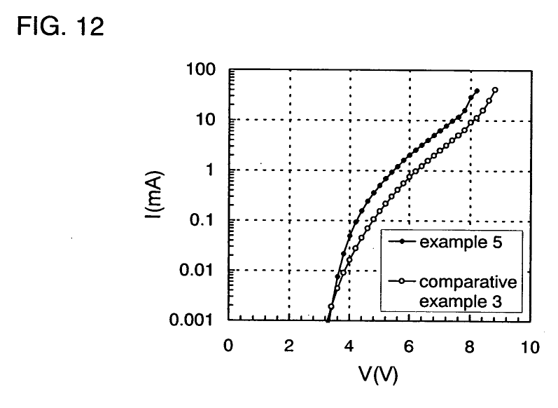

From the foregoing results, the driving voltage of the electroluminescent device according to the invention can be reduced although the peak wavelength of an emission spectrum is slightly blue-shifted. FIG. 12 shows current vs. voltage characteristics of the electroluminescent devices explained in Example 5 and Comparative Example 3. As is shown in FIG. 12, a current flow became easily in line with expectations by practicing the present invention.

### EXAMPLE 6

In Example 6, an example of a method for manufacturing an electroluminescent device by a guest material having an electron-withdrawing group different from those described in Examples 1 and 2 is specifically explained. FIG. 5 shows the device configuration of the electroluminescent device.

An anode 501 was formed over a glass substrate 500 having an insulated surface. As a material for the anode 501, ITSO was used. The anode 501 was deposited by sputtering to have a thickness of 110 nm. The size of the anode 501 was 2×2 mm.

After washing and drying the substrate provided with the anode 501, an electroluminescent layer 502 was formed over the anode 501. Firstly, the substrate provided with the anode 501 was secured so as to be face down by a substrate holder installed in a vacuum deposition device. That is, the surface provided with the anode 501 was placed face down. Then, DNTPD was deposited to have a thickness of 50 nm by vacuum vapor deposition with resistance heating. The deposited film serves as a hole injecting layer 511. Secondly, α-NPD that is a hole transportation material was deposited to have a thickness of 10 nm in accordance with the same procedure as that for the hole injecting layer. The deposited film serves as a hole transporting layer 512.

As a host material 521 for a light-emitting layer 513, α-NPD that is a hole transportation material was used. As a guest material 522 having an electron-withdrawing group for the light-emitting layer 513, coumarin 153 was used. The light-emitting layer 513 was formed by co-evaporation of the host material and the guest material so that the concentration of the coumarin 153 is 0.5 mass %. The light-emitting layer 513 was formed to have a thickness of 30 nm. The coumarin 153 is a compound having a halogeno group that is an electron-withdrawing group, since it has a trifluoromethyl group.

Then, BAlq and Alq₃, each of which is an electron transportation material, were deposited with thicknesses of 10 nm and 20 nm, respectively, to form an electron transporting layer 514 by vacuum vapor deposition. And then, CaF₂ was deposited as an electron injecting layer 515 with a thickness of 1 nm by vacuum vapor deposition. Thus formed hole injecting layer 511, the hole transporting layer 512, the light-emitting layer 513, the electron transporting layer 514, and the electron injecting layer 515 serve as an electroluminescent layer 502. The electroluminescent layer 502 has a total thickness of 121 nm.

Lastly, a cathode 503 was formed. According to Example 6, aluminum (Al) was deposited to have a thickness of 150 nm as the cathode 503 by vacuum vapor deposition with resistance heating.

When voltage of 6.0 V was applied to thus manufactured electroluminescent device according to the invention, current (current density) flowed at 30.3 mA/cm², and a luminance of 659 cd/m² was obtained. The peak wavelength of an emission spectrum was at 499 run.

### COMPARATIVE EXAMPLE 4

The conventional electroluminescent device including a light-emitting layer formed by an electron transportation material added with a guest material having an electron-withdrawing group was manufactured to compare with the electroluminescent device explained in Example 6. The device configuration of the electroluminescent device is the same as that explained in Example 6 except a light-emitting layer 513 and an electron transporting layer 514.

As a host material for a light-emitting layer 513, BAlq that is an electron transporting material was used. As a guest material having an electron-withdrawing group for the light-emitting layer 513, coumarin 153, which is also used in Example 6, was used. The light-emitting layer 513 was formed by co-evaporation of the host material and the guest material so that the concentration of the coumarin 153 was 0.5 mass %. The light-emitting layer 513 was formed to have a thickness of 30 nm. Further, an electron transporting layer 514 was formed by Alq₃ to have a thickness of 30 nm by vacuum vapor deposition. An electroluminescent layer 502 has a total thickness of 121 nm that is the same as that explained in Example 6.

When voltage of 6.0 V was applied to thus manufactured electroluminescent device according to the invention, current (current density) flowed at 0.262 mA/cm², and a luminance of 14.4 cd/m² was obtained. The peak wavelength of an emission spectrum was at 517 nm.

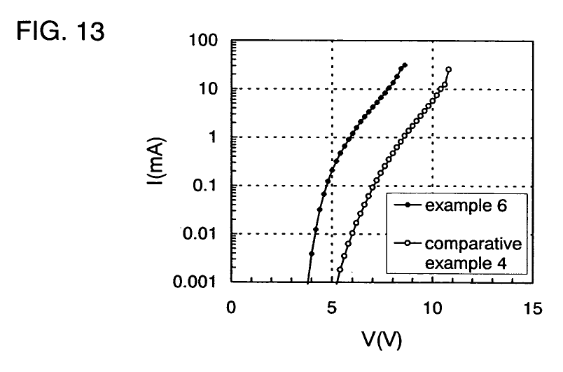

From the foregoing results, the driving voltage of the electroluminescent device according to the invention can be reduced although the peak wavelength of an emission spectrum is slightly blue-shifted. FIG. 13 shows current vs. voltage characteristics of the electroluminescent devices explained in Example 6 and Comparative Example 4. As is shown in FIG. 13, a current flow became easily in line with expectations by practicing the present invention.

### EXAMPLE 7

In Example 7, an example of a method for manufacturing an electroluminescent device by a guest material having an electron-withdrawing group different from those described in Examples 1, 2, 5, 6 is specifically explained. FIG. 5 shows the device configuration of the electroluminescent device.

An anode 501 was formed over a glass substrate 500 having an insulated surface. As a material for the anode 501, ITSO was used. The anode 501 was deposited by sputtering to have a thickness of 110 nm. The size of the anode 501 was 2×2 mm.

After washing and drying the substrate provided with the anode 501, an electroluminescent layer 502 was formed over the anode 501. Firstly, the substrate provided with the anode 501 was secured so as to be face down by a substrate holder installed in a vacuum deposition device. That is, the surface provided with the anode 501 was placed face down. Then, DNTPD was deposited to have a thickness of 50 nm by vacuum vapor deposition with resistance heating. The deposited film serves as a hole injecting layer 511. Secondly, α-NPD that is a hole transportation material was deposited to have a thickness of 10 nm in accordance with the same procedure as that for the hole injecting layer. The deposited film serves as a hole transporting layer 512.

As a host material 521 for a light-emitting layer 513, α-NPD that is a hole transportation material was used. As a guest material 522 having an electron-withdrawing group for the light-emitting layer 513, coumarin 334 was used. The light-emitting layer 513 was formed by co-evaporation using the host material and the guest material so that the concentration of the coumarin 334 is 0.5 mass %. The light-emitting layer 513 was formed to have a thickness of 30 nm. The coumarin 334 is a compound having a carbonyl group that is an electron-withdrawing group, since it has a acetyl group.

Then, BAlq and Alq₃, each of which is an electron transportation material, were deposited with thicknesses of 10 nm and 20 nm, respectively, to form an electron transporting layer 514 by vacuum vapor deposition. And then, CaF₂ was deposited as an electron injecting layer 515 with a thickness of 1 nm by vacuum vapor deposition. Thus formed hole injecting layer 511, the hole transporting layer 512, the light-emitting layer 513, the electron transporting layer 514, and the electron injecting layer 515 serve as an electroluminescent layer 502. The electroluminescent layer 502 has a total thickness of 121 nm.

Lastly, a cathode 503 was formed. According to Example 6, aluminum (Al) was deposited to have a thickness of 150 nm as the cathode 503 by vacuum vapor deposition with resistance heating.

When voltage of 6.0 V was applied to thus manufactured electroluminescent device according to the invention, current (current density) flowed at 11.0 mA/cm², and a luminance of 220 cd/m² is obtained. The peak wavelength of an emission spectrum was at 477 nm.

### COMPARATIVE EXAMPLE 5

The conventional electroluminescent device including a light-emitting layer formed by an electron transportation material added with a guest material having an electron-withdrawing group was manufactured to compare with the electroluminescent device explained in Example 7. The device configuration of the electroluminescent device is the same as that explained in Example 7 except a light-emitting layer 513 and an electron transporting layer 514.

As a host material for a light-emitting layer 513, BAlq that is an electron transporting material was used. As a guest material for the light-emitting layer 513, coumarin 334 having an electron-withdrawing group, which is also used in Example 7, was used. The light-emitting layer 513 was formed by co-evaporation of the host material and the guest material so that the concentration of the coumarin 334 is 0.5 mass %. The light-emitting layer 513 was formed to have a thickness of 30 nm. An electroluminescent layer 502 has a total thickness of 121 nm that is the same as that explained in Example 7.

When voltage of 6.0 V was applied to thus manufactured electroluminescent device according to the invention, current (current density) flowed at 1.07 mA/cm², and a luminance of 42.5 cd/m² was obtained. The peak wavelength of an emission spectrum was at 485 nm.

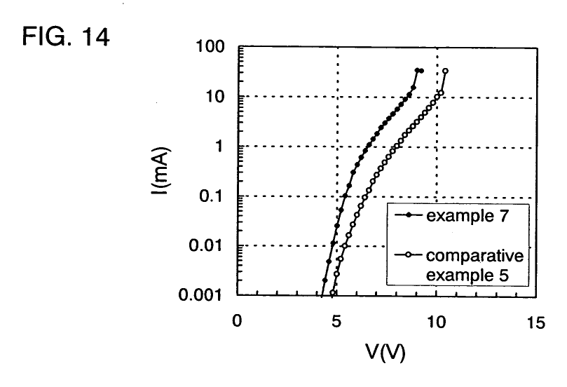

From the foregoing results, the driving voltage of the electroluminescent device according to the invention can be reduced although the peak wavelength of an emission spectrum is slightly blue-shifted. FIG. 14 shows current vs. voltage characteristics of the electroluminescent devices explained in Example 7 and Comparative Example 5. As is shown in FIG. 14, a current flow became easily in line with expectations by practicing the present invention.

Although the present invention has been fully described by way of examples with reference to the accompanying drawings, it is to be understood that various changes and modifications will be apparent to those skilled in the art. Therefore, unless otherwise such changes and modifications depart from the scope of the present invention hereinafter described, they should be construed as being included therein.

1. An electroluminescent device comprising:
a light-emitting layer containing a host material and a guest material having an electron-withdrawing group; and
an electron transporting layer formed adjacent to the light-emitting layer;
wherein the host material is an organic compound having a hole transportation property.

2. The electroluminescent device according to claim 1, wherein the host material is an organic compound having an aromatic amine skeleton.

3. The electroluminescent device according to claim 1, wherein a peak wavelength of an emission spectrum of the guest material is in a range of 560 to 700 nm.

4. The electroluminescent device according to claim 1, wherein an ionization potential of the host material is larger by 0.3 eV or more than the ionization potential of an electron transportation material used for the electron transporting layer.

5. The electroluminescent device according to claim 4, wherein the ionization potential of the host material is at most 5.1 eV.

6. The electroluminescent device according to claim 4, wherein the ionization potential of the electron transportation material is at least 5.6 eV.

7. The electroluminescent device according to claim 1, wherein a hole trap region, which can trap holes, and which is formed by a hole trap material having smaller energy gap than the energy gap of an electron transportation material used for the electron transporting layer, is provided between the light-emitting layer and the electron transporting layer.

8. The electroluminescent device according to claim 7, wherein the hole trap material has smaller ionization potential than the ionization potential of the host material and the electron transportation material.

9. The electroluminescent device according to claim 7, wherein the hole trap region is formed into a layer with a thickness of at most 5 nm.

10. The electroluminescent device according to claim 7, wherein the hole trap region is formed into an island-like shape.

11. The electroluminescent device according to claim 7, wherein the hole trap material is an aromatic hydrocarbon compound having a carbon number of at least 18, or a carbon allotrope.

12. The electroluminescent device according to claim 1, wherein a peak wavelength of an emission spectrum of the guest material is in a range of 600 to 700 nm, and a dipole moment of molecules of the host material is at least 4 debye.

13. A light-emitting device having the electroluminescent device according to claim 1.

14. An electric appliance having the light-emitting device according to claim 13.

15. An electroluminescent device comprising:
a light-emitting layer containing a host material and a guest material having a cyano group; and
an electron transporting layer formed adjacent to the light-emitting layer;
wherein the host material is an organic compound having a hole transportation property.

16. The electroluminescent device according to claim 15, wherein the host material is an organic compound having an aromatic amine skeleton.

17. The electroluminescent device according to claim 15, wherein a peak wavelength of an emission spectrum of the guest material is in a range of 560 to 700 nm.

18. The electroluminescent device according to claim 15, wherein an ionization potential of the host material is larger by 0.3 eV or more than the ionization potential of an electron transportation material used for the electron transporting layer.

19. The electroluminescent device according to claim 18, wherein the ionization potential of the host material is at most 5.1 eV.

20. The electroluminescent device according to claim 18, wherein the ionization potential of the electron transportation material is at least 5.6 eV.

21. The electroluminescent device according to claim 15, wherein a hole trap region, which can trap holes, and which is formed by a hole trap material having smaller energy gap than the energy gap of an electron transportation material used for the electron transporting layer, is provided between the light-emitting layer and the electron transporting layer.

22. The electroluminescent device according to claim 21, wherein the hole trap material has smaller ionization potential than the ionization potential of the host material and the electron transportation material.

23. The electroluminescent device according to claim 21, wherein the hole trap region is formed into a layer with a thickness of at most 5 nm.

24. The electroluminescent device according to claim 21, wherein the hole trap region is formed into an island-like shape.

25. The electroluminescent device according to claim 21, wherein the hole trap material is an aromatic hydrocarbon compound having a carbon number of at least 18, or a carbon allotrope.

26. The electroluminescent device according to claim 15, wherein a peak wavelength of an emission spectrum of the guest material is in a range of 600 to 700 nm, and a dipole moment of molecules of the host material is at least 4 debye.

27. A light-emitting device having the electroluminescent device according to claim 15.

28. An electric appliance having the light-emitting device according to claim 27.

29. An electroluminescent device comprising:
a light-emitting layer containing a host material and a guest material having a halogeno group; and
an electron transporting layer formed adjacent to the light-emitting layer;
wherein the host material is an organic compound having a hole transportation property.

30. The electroluminescent device according to claim 29, wherein the host material is an organic compound having an aromatic amine skeleton.

31. The electroluminescent device according to claim 29, wherein a peak wavelength of an emission spectrum of the guest material is in a range of 560 to 700 nm.

32. The electroluminescent device according to claim 29, wherein an ionization potential of the host material is larger by 0.3 eV or more than the ionization potential of an electron transportation material used for the electron transporting layer.

33. The electroluminescent device according to claim 32, wherein the ionization potential of the host material is at most 5.1 eV.

34. The electroluminescent device according to claim 32, wherein the ionization potential of the electron transportation material is at least 5.6 eV.

35. The electroluminescent device according to claim 29, wherein a hole trap region, which can trap holes, and which is formed by a hole trap material having smaller energy gap than the energy gap of an electron transportation material used for the electron transporting layer, is provided between the light-emitting layer and the electron transporting layer.

36. The electroluminescent device according to claim 35, wherein the hole trap material has smaller ionization potential than the ionization potential of the host material and the electron transportation material.

37. The electroluminescent device according to claim 35, wherein the hole trap region is formed into a layer with a thickness of at most 5 nm.

38. The electroluminescent device according to claim 35, wherein the hole trap region is formed into an island-like shape.

39. The electroluminescent device according to claim 35, wherein the hole trap material is an aromatic hydrocarbon compound having a carbon number of at least 18, or a carbon allotrope.

40. The electroluminescent device according to claim 29, wherein a peak wavelength of an emission spectrum of the guest material is in a range of 600 to 700 nm, and a dipole moment of molecules of the host material is at least 4 debye.

41. A light-emitting device having the electroluminescent device according to claim 29.

42. An electric appliance having the light-emitting device according to claim 41.

43. An electroluminescent device comprising:
a light-emitting layer containing a host material and a guest material having a carbonyl group; and
an electron transporting layer formed adjacent to the light-emitting layer;
wherein the host material is an organic compound having a hole transportation property.

44. The electroluminescent device according to claim 43, wherein the host material is an organic compound having an aromatic amine skeleton.

45. The electroluminescent device according to claim 43, wherein a peak wavelength of an emission spectrum of the guest material is in a range of 560 to 700 nm.

46. The electroluminescent device according to claim 43, wherein an ionization potential of the host material is larger by 0.3 eV or more than the ionization potential of an electron transportation material used for the electron transporting layer.

47. The electroluminescent device according to claim 46, wherein the ionization potential of the host material is at most 5.1 eV.

48. The electroluminescent device according to claim 46, wherein the ionization potential of the electron transportation material is at least 5.6 eV.

49. The electroluminescent device according to claim 43, wherein a hole trap region, which can trap holes, and which is formed by a hole trap material having smaller energy gap than the energy gap of an electron transportation material used for the electron transporting layer, is provided between the light-emitting layer and the electron transporting layer.

50. The electroluminescent device according to claim 49, wherein the hole trap material has smaller ionization potential than the ionization potential of the host material and the electron transportation material.

51. The electroluminescent device according to claim 49, wherein the hole trap region is formed into a layer with a thickness of at most 5 nm.

52. The electroluminescent device according to claim 49, wherein the hole trap region is formed into an island-like shape.

53. The electroluminescent device according to claim 49, wherein the hole trap material is an aromatic hydrocarbon compound having a carbon number of at least 18, or a carbon allotrope.

54. The electroluminescent device according to claim 43, wherein a peak wavelength of an emission spectrum of the guest material is in a range of 600 to 700 nm, and a dipole moment of molecules of the host material is at least 4 debye.

55. A light-emitting device having the electroluminescent device according to claim 43.

56. An electric appliance having the light-emitting device according to claim 55.

57. An electroluminescent device comprising:
a light-emitting layer containing a host material and a guest material having a 4-dicyanomethylene-4H-pyrane skeleton; and
an electron transporting layer formed adjacent to the light-emitting layer;
wherein the host material is an organic compound having a hole transportation property.

58. The electroluminescent device according to claim 57, wherein the host material is an organic compound having an aromatic amine skeleton.

59. The electroluminescent device according to claim 57, wherein a peak wavelength of an emission spectrum of the guest material is in a range of 560 to 700 nm.

60. The electroluminescent device according to claim 57, wherein an ionization potential of the host material is larger by 0.3 eV or more than the ionization potential of an electron transportation material used for the electron transporting layer.

61. The electroluminescent device according to claim 60, wherein the ionization potential of the host material is at most 5.1 eV.

62. The electroluminescent device according to claim 60, wherein the ionization potential of the electron transportation material is at least 5.6 eV.

63. The electroluminescent device according to claim 57, wherein a hole trap region, which can trap holes, and which is formed by a hole trap material having smaller energy gap than the energy gap of an electron transportation material used for the electron transporting layer, is provided between the light-emitting layer and the electron transporting layer.

64. The electroluminescent device according to claim 63, wherein the hole trap material has smaller ionization potential than the ionization potential of the host material and the electron transportation material.

65. The electroluminescent device according to claim 63, wherein the hole trap region is formed into a layer with a thickness of at most 5 nm.

66. The electroluminescent device according to claim 63, wherein the hole trap region is formed into an island-like shape.

67. The electroluminescent device according to claim 63, wherein the hole trap material is an aromatic hydrocarbon compound having a carbon number of at least 18, or a carbon allotrope.

68. The electroluminescent device according to claim 57, wherein a peak wavelength of an emission spectrum of the guest material is in a range of 600 to 700 nm, and a dipole moment of molecules of the host material is at least 4 debye.

69. A light-emitting device having the electroluminescent device according to claim 57.

70. An electric appliance having the light-emitting device according to claim 69.
